(19) United States
(12) Patent Application Publication
(10) Pub. No.: US 2022/0207524 A1
(43) Pub. Date: Jun. 30, 2022

(54) CONVERGENT DIGITAL IDENTITY BASED SUPERTOKENIZATION

(71) Applicant: IDEMIA IDENTITY & SECURITY USA LLC, Reston, VA (US)

(72) Inventors: Darrell K. Geusz, Sterling, VA (US); Stephen Miu, Chelmsford, MA (US); Michele P. Pilotte, Westford, MA (US)

(21) Appl. No.: 17/566,414

(22) Filed: Dec. 30, 2021

Related U.S. Application Data
(60) Provisional application No. 63/132,809, filed on Dec. 31, 2020.

(51) Int. Cl. G06Q 20/38; G06Q 20/40; H04L 9/14

(52) U.S. Cl. CPC G06Q 20/3829; G06Q 20/4014; G06Q 2220/00; H04L 9/14; G06Q 20/409

(57) ABSTRACT

A system for combining tokens is provided. The system includes a computer device including at least one processor in communication with at least one memory device. The at least one processor is programmed to: a) receive identity information for an individual, b) receive device identity information for the computer device, c) combine the identity information and the device identity information to generate a base token, d) receive payment card information for a payment card associated with the individual, and e) combine the base token with the payment card information to generate a supertoken.

### CROSS-REFERENCE TO RELATED APPLICATIONS

This application claims priority to U.S. Provisional Patent Application No. 63/132,809 filed on Dec. 31, 2020 titled Convergent Digital Identity Based Supertokenization, the entire contents of which are hereby incorporated herein by reference.

### FIELD

The field of the disclosure relates generally to identity management and, more specifically, to binding multiple identity tokens for a plurality of identities associated with a plurality of digital ecosystems, including government-issued identity tokens and identity tokens for financial systems.

### BACKGROUND

Individuals may possess, or be associated with, multiple identity tokens associated with multiple diverse digital ecosystems, where the various identity tokens allow a given individual to gain access to the different ecosystems. However, having multiple tokens can be unwieldy and difficult to manage. It is desirable to have method by which a single token may be used with, or tied to, multiple diverse, or separate, digital ecosystems.

### BRIEF DESCRIPTION

A system for combining tokens is provided. The system includes a computer device including at least one processor in communication with at least one memory device. The at least one processor is programmed to: a) receive identity information for an individual, b) receive device identity information for the computer device, c) combine the identity information and the device identity information to generate a base token, d) receive payment card information for a payment card associated with the individual, and e) combine the base token with the payment card information to generate a supertoken.

### BRIEF DESCRIPTION OF THE DRAWINGS

FIG. 1 illustrates a block diagram combining a plurality of identifiers to a single supertoken in accordance with at least one embodiment.

FIG. 2 illustrates a block diagram of connecting identity token, device tokens, payment tokens, and other tokens to create a supertoken.

FIG. 3 illustrates an example layout for a supertoken in accordance with at least one embodiment.

FIG. 4 illustrates combining multiple systems to government issued identification.

FIG. 5 illustrates combining multiple systems to a base issued identification in a further embodiment.

FIG. 6 illustrates a flow chart of using the supertoken shown in FIGS. 1 and 2 in a shopping setting.

FIGS. 7A and 7B illustrate flow charts of using the supertoken 125 shown in FIGS. 1 and 2 in transaction settings.

FIG. 8 illustrates a block diagram of an exemplary system for supporting the supertoken shown in FIGS. 1 and 2.

FIG. 9 illustrates a block diagram of an exemplary system for using the supertoken shown in FIGS. 1 and 2.

FIG. 10 illustrates a block diagram of a system for connecting multiple tokens.

FIG. 11 illustrates a block diagram of a system integrating digital wallets with supertokens.

### DETAILED DESCRIPTION

The field of the invention relates generally to identity management and, more specifically, to binding identity tokens for a plurality of identities associated with different digital ecosystems, including identities associated with financial ecosystems. The identity attributes represent or incorporate one or more credentials, attributes, privileges, identity proofing or vetting resources/process/results, affiliations/memberships, and/or validity/status. The ability to transfer multiple identity attributes simultaneously within one discrete transaction cycle is desired. The system provides the affected relying parties with the information they need, quicker and with confidence. The system also provides the ability to enable an end-user to more easily assert and confirm their identity digitally, without the very physical and time-consuming problem of selecting the identity attributes to be asserted based on the specific workflow challenge.

The system described herein generates a base token, or a tokenized algorithmic output, representing the relevant confirmation and presentation of specific identity attributes that are required and validated by a government entity (or other secure entity). The identity attributes of the base token are subsequently consumed by multiple relying parties in parallel while confirmation of identity is performed. This base token can be combined with additional attributes associated with a third party to create a derived token. Additionally, the base token can instead be combined with the additional attributes associated with a third party's digital ecosystem to create a supertoken. The supertoken can also be combined with the additional attributes from other third parties' digital ecosystems to allow access to those additional attributes. The system described herein supports multiple benefits at multiple levels of the OSI Model.

The supertoken is based on a binding established between a government backed, or government issued, digital identity for an individual and one or more other identities for different digital ecosystems. Other digital ecosystems may include those for financial institutions, loyalty programs, events, hospitality, IoT, or healthcare. The supertoken (or base token) is generated in coordination with an identity of an individual based on attributes shared with or by a governmental entity, e.g., a government agency or a representative entity for that government agency. The governmental entity could be at the federal, state, or local level. For example, the entity could be a federal government that signs the token based on the presentation of personally identifiable information (PII) associated with the individual's passport. The government backs, or signs, the individual's digital credential, or token, ascribing a higher level of trust for potential relying parties.

Relying parties (RP) may have different rights to extract. Generally speaking, the system gives RPs a license to decode certain elements of the supertoken, suited for their line of business. Since the RP's portion of the supertoken would be defined algorithmically, the RP knows where their important fields sit in the string. In some further embodiments, the RPs could be granted licenses to access/participate in issuing and decoding supertokens. In these embodiments, the RP's specific token could then be encoded or keyed with the RP's public key. The RP then finds the public key and extracts the associated token. Then the RP decodes the token using their private key. In many ways this system could be set-up to emulate a public key infrastructure (PKI).

In further embodiments, there may be keys that are provided to RPs to extract only a portion of the supertoken. In these embodiments, the RPs are provisioned those unlock and parse keys based on use case and business needs, or can simply choose to instantiate one or more keys based on specific transaction or step. The RPs may be registered or be a certified organization. There could also be multiple keys and bindings, including the RP's key or certificate and/or issuer key or certificate in the mix, for extra security.

In some embodiments, a correlation might be similar to some parts of a blockchain, where each ledger system appends their token key to the chain. When a transaction to be verified is noted, the RP scans the chain looking for their token. Another correlation might be a digital keychain of sorts, where an entire keychain is presented, but a relying party (website) is only looking for the one key they are interested in noting the person's identity or rights to access the site.

As a result, the supertoken is distinctly NOT like the visual rendering of a mobile ID (mID), where the individual must choose to withhold certain personally identifiable information (PII) before presenting it to a challenging party. The supertoken systems and methods described herein are also distinct from blockchain, but could be configured to be run in parallel with blockchain.

The systems and processes are not limited to the specific examples described herein. In addition, components of each system and each process can be practiced independent and separate from other components and processes described herein. Each component and process also can be used in combination with other assembly packages and processes.

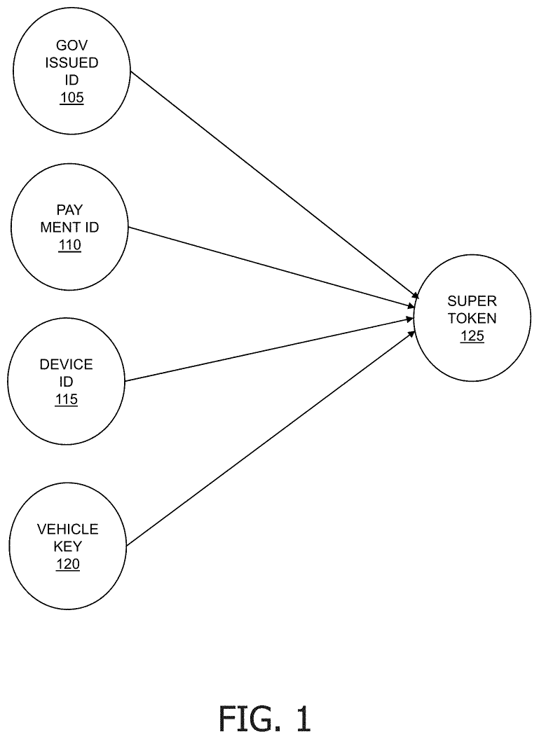

FIG. 1 illustrates a block diagram combining a plurality of identifiers 100 into a single supertoken 125 in accordance with at least one embodiment. As shown in FIG. 1, multiple identifiers 100 for an individual can be combined into a supertoken 125. Example identifiers 100 shown in FIG. 1 include a government issued identifier 105, such as a passport number, a driver's license number, or a social security number. The example identifiers 100 also include a payment identifier 110, such as, a payment account number, a debit card number, or a token representing a payment account number. In some states, government services can be offered in overlapping cash-based programs that may be administrated through debit cards (or other types of payment cards) associated with a personal account number (PAN) or an account ID (AID). The example identifiers 100 also include a device identifier 115, which would be a unique identifier for the device, such as a mobile phone or other smart device, or the subscriber identity module (SIM) chip of the mobile device the supertoken 125 is to be stored on and associated with. The example identifier 100 can also include a digital or contactless key 120, such as a vehicle key, a house key, or other key to access a location or vehicle. Many Internet of Things (IoT) devices include subscriber modules and generate tokens that can be integrated into the supertoken 125.

Each one of these identifiers 100 can be represented by a token the user stores on a device, such as a mobile device or smartphone. However, the number of tokens can get confusing and generally the user does not have access to the tokens or the information the token provides each time the corresponding token is used. Accordingly, FIG. 1 illustrates binding those tokens together into a single supertoken 125 that may be used with all of the corresponding digital ecosystems.

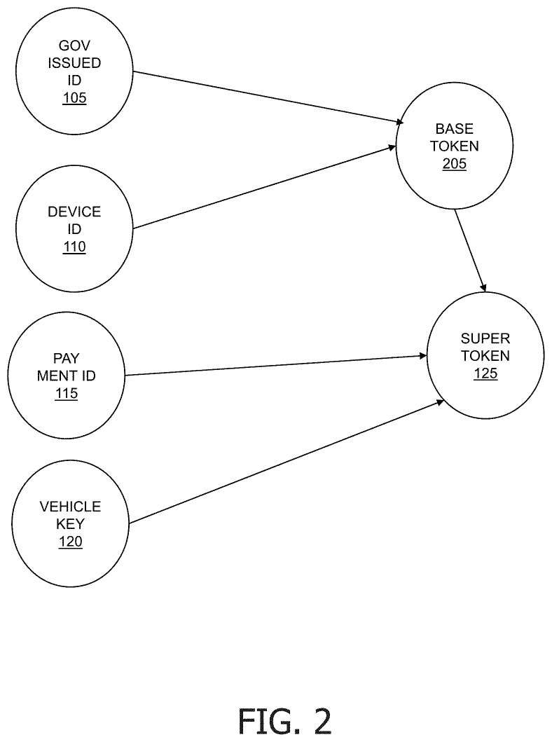

FIG. 2 illustrates a block diagram of binding an identity token, device tokens, payment tokens, and other tokens to create a supertoken 125. A government issued identifier 105 is combined with a device identifier 110 for a mobile device to build a base token 205 on the mobile device. The base token 205 is bound to other accounts, such as a payment account identifier 115 and/or a vehicle key identifier 120 or other identifier to generate a supertoken 125. The supertoken 125 can then be used to access the payment account, vehicle, or other bound or linked account.

In the exemplary embodiment, the supertoken 125 is based on a government backed digital identity 105 (or other issuing authority backed) for an individual. In this embodiment, the base token 205 is generated in coordination with an identity of an individual based on the original or verified attributes shared by or with the original issuer, such as a governmental entity, where the governmental entity could be at the federal, state, or local level. For example, the entity could be a federal government and the base token is based on the individual's passport. In another example, the entity could be a state government and the base token is connected to the individual's driver's license. In many embodiments, the government (or other issuing authority) backs or verifies the individual's core or fundamental credentials, such as, but not limited to, credentials, attributes, privileges, identity proofing or vetting resources/process/results, affiliations/memberships, and/or validity/status. In other embodiments, the individual's core or fundamental credentials can be backed by another issuing authority, such as a business, school, or other secure domain of trust.

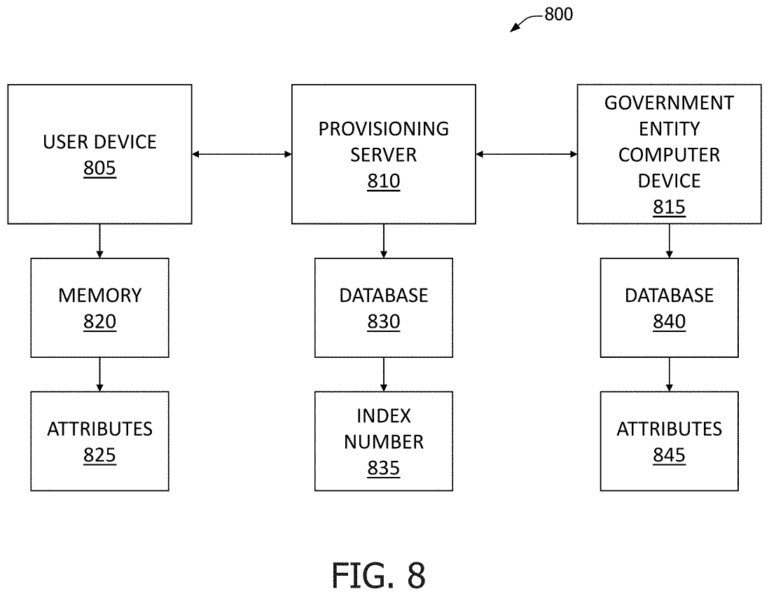

A digital identity of the user is stored with a governmental entity (or other domain of trust entity). The government-based digital identity 105 is used as the base starting point for the supertoken 125. In the exemplary embodiment, a token provisioning server 810 (shown in FIG. 8) takes the government backed digital identity 105 and generates and signs a base token 205 on behalf of that governmental entity. In some embodiments, the base token 205 is generated alone and the other tokens are bound to that base token 205 to create the supertoken 125. In other embodiments, multiple tokens are collected and/or verified at the time of identity proofing, vetting, and/or provisioning to generate and sign the base token 205, which then functions as the supertoken 125. Different levels of trust of the base token may be included in the base token 205 based on how the base token 205 was generated. For example, if the base token 205 was generated while the individual was at an office of the government entity, or government designated 3^{rd} party, then the base token 205 may be considered at a first (high) level of trust. If the base token 205 was generated while the individual was remote, the base token 205 would be considered at a second (not as high) level of trust. Different identity proofing, vetting and binding methods and processes used when the multiple tokens are collected and/or verified at the time of identity proofing, vetting and/or provisioning to generate and sign the base token can also determine the level of trust, regardless if the individual is remote or in-person.

In other embodiments, the base token 205 may be based on a different domain of trust that certifies that the user is the owner of the token. For example, in a school setting, a student may have a set of credentials in supertoken form provided by the school. The student can then use their supertoken 125 to access the different facilities and services provided by the school. In this case the domain of trust is provided by the school rather than the government.

In some embodiments, the base token 205 can provide the template of information and/or process that was used in creating the base token 205. In further embodiments, the base token 205 can provide the template of information and/or process that was used in binding any other token to the base token 205 to create the supertoken 125. This can include whether the original issuer system of record was included in the process, or whether the process included 3^{rd} party authoritative systems or information derived from a physical credential or ID card. The template of information can be used to provide information to relying parties creating derived tokens from the base token 205. The derived token may be based on a hierarchy of consumption of the secure identity. Each relying party wants a close associated with the identity. For example, a derived banking token would only get issued with the bank knows that the individual is who they say they are, aka verified government identification.

Each separate token can include its own attributes, identifying information, and information pertinent to the relying party's ecosystem/workflow. The provisioning server 810 determines where to put each of the attributes in the base token 205 and/or the supertoken 125. In the exemplary embodiment, the token and the attributes are stored on the user's mobile device, while the provisioning server 810 stores an index or identifier of the token. The index or identifier could be based on the governmental identifier, such as the driver's license ID number. For security purposes, the index or identifier could be hashed and/or salted to protect the user's privacy. The token's attributes may also include one or more biometric identifiers to confirm the identity of the user of the token and the corresponding mobile device.

In the exemplary embodiment, the base token 205 or supertoken 125 is stored in a secure enclave or element in the hardware of the mobile device or smart phone. In some embodiments, the base token 205 or supertoken 125 is linked to information in the secure enclave or secure element. In further embodiments, the base token or secure token is stored on a subscriber identification module (SIM) card in the mobile device. In still further embodiments, the base token 205 or supertoken 125 is stored in the trusted platform module (TPM) of the mobile device. In still further embodiments, the base token 205 or supertoken 125 is stored in the keystore/keychain managed by the operating system of the mobile device.

Different accounts may require different credentials for their tokens. To bind a token to the base token 205 or supertoken 125, the base token 205 or supertoken 125 needs to provide the required credentials to the account. However, in some cases, the base token 205 or supertoken 125 may be missing one or more of the required credentials. In these cases, the provisioning server 810 or other binding computer device may substitute other credentials for the missing credentials. The substituted credentials may be provided based on a list of credentials and their associated security. For example, if a lower security credential is missing, then the provisioning server 810 may request a higher security credential to substitute for the missing credential. In one example, if a facial scan is unavailable, the system may substitute the facial scan with an available fingerprint scan or iris scan. In additional embodiments, the issuer, designated 3^{rd} party, or relying party may defer, share, or license their token to a competitor or standards organization.

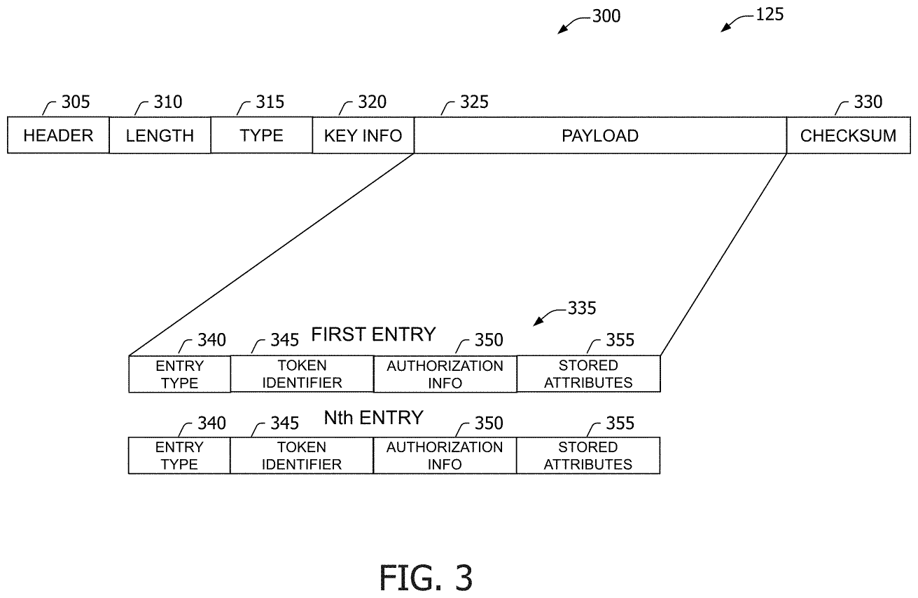

FIG. 3 illustrates an example layout 300 for a supertoken 125 in accordance with at least one embodiment. In the exemplary embodiment, a token is an alphanumeric string that encodes the identifying credentials and information to allow the user to access a system and to prove to the system that the user is the correct individual. The token shown here in FIG. 3 is an exemplary string of data. The layout 300 is for illustration purposes and the fields and information contained in the token may be rearranged and/or changed based on the systems accessing the token and the security needs for protecting the information contained within. In the exemplary embodiment, the information contained within the token is encrypted, such as through Public Key Infrastructure or other encryption scheme.

The layout 300 includes, for example, a header field 305, a length field 310, a type field 315, a key information field 320, a payload 325, and a checksum field 330. The length field 310 may give information on how many bits or bytes are in the token. The type field 315 may indicate which type of token is contained in this string. For example, the type field could indicate if the token is a base token (containing domain of trust and device information), a derived token (containing base token information and information on one third-party), or a supertoken (containing base token information and information on multiple third-parties). A system reading the token may use the length field 310 and the type field 315 to determine which type of token it is. The type field 315 can also give an indication of the format used to store the data in the payload 325. The key information field 320 may contain information about the encryption key used to encrypt the data in the payload 325. The checksum field 330 confirms the integrity of the token itself and can be replaced with other integrity and error checking methods, such as, but not limited to, a cyclic redundancy check (CRC) and a parity check.

In this embodiment, the payload 325 includes one or more entries 335. Each entry 335 is made up of multiple fields that include information for authenticating the owner of the token and/or providing access information for one of more third-party systems. Example information can include, entry type 340, token identifier 345, authorization information 350, and stored attributes 355. Each entry may have more or less information as needed.

When a system access the token, the system knows where its information for access is placed in the layout 300 of the token. This location information may be provided by the type field 315. In other embodiments, the location information may be found by searching through the entry type fields 340 for all of the entries 335 until the desired entry is found in the payload 325.

In some embodiments, different entries 335 may be encrypted using different encryption methods. Furthermore, some entries 335 may be double encrypted, with one encryption associated with the user and/or the user device and the other encryption associated with the relying party associated with that entry.

In these embodiments, the RP's specific token could then be encoded or keyed with the RP's public key. The RP then finds the public key in the layout 300 of the supertoken 125 and extracts the associated token. Then the RP decodes the token using their private key. In many ways this system could be set-up to emulate a public key infrastructure (PKI).

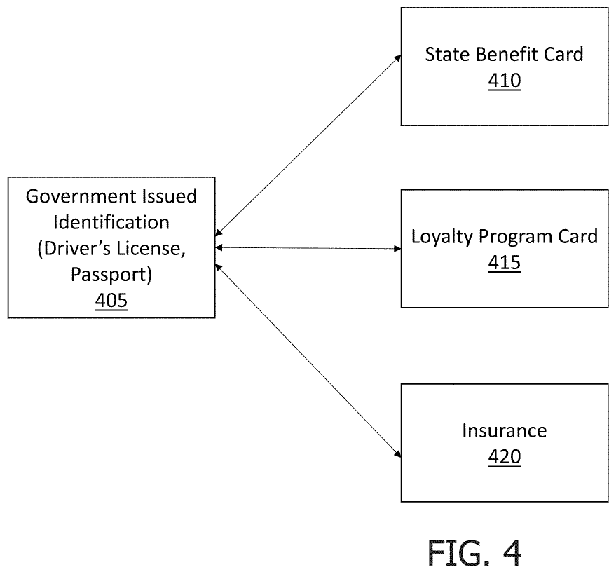

FIG. 4 illustrates combining multiple systems to government issued identification 405. In FIG. 4, the government issued identification 405, such as a driver's license, is associated with a state benefit card 410, which could be a debit card, a payment card, and/or other payment account. These associated payment accounts through the state benefit card 410 could be used for governmentally issued funds, such as, but not limited to, unemployment benefits and supplemental nutrition assistance program (SNAP) funds. The funds could be transferred to the state benefit card 410 and the corresponding payment account. Then the corresponding individual can use the state benefit card 410 to pay for food and other necessities, or to pay child support. In some embodiments, tax refunds could be placed in the associated payment account.

The government issued identification 405 is used to create a base token 205 (shown in FIG. 2) that can also bound to loyalty program cards 415, such as those associated with different vendors. The base token 205 can also be bound to an insurance policy 420 associated with the individual. In addition, the base token 205 can be bound to vehicles associated with the individual. For example, an individual may have a fleet of four vehicles and the four vehicles are all bound to the base token 205. This can be as separate derived tokens, or all combined in a single supertoken 125. The individual can then use the connected token to start and/or unlock each of the bound vehicles.

In a family setting, the individual could also bind the base token 205 to each cellphone on the individual's cellphone plan. Then the individual/account owner can create a dependent token for each of his/her dependents to allow them access to one of the phones and/or one of the vehicles. The dependent token can then be used by the assigned dependent. However, the account owner still has control over the dependent token and can change the systems the dependent token has access to. For example, when a dependent is grounded, their dependent token may have access to their vehicle revoked. If a dependent is going on a trip, their dependent token may have access to a payment account of the account owner for emergencies. For additional security, the individual may be notified or asked for secondary authorization when the dependent uses the payment account.

Another potential use case for the dependent token would be tying a new driver to particular vehicles in the family fleet based on insurance contracts and or limitations of “validity”—i.e. in Massachusetts a junior operator license is not valid from 0000 to 0500. The vehicle reading the key should be able to block or disable the vehicle or send an alert to a parent, etc. Furthermore, there also may be an emergency override, where if the adult/parent has fallen ill or injured the dependent could still use the token to activate the vehicle outside of the normal parameters. However, the emergency use would be registered and stored so that the parent could tell when the dependent used the emergency access to prevent abuse.

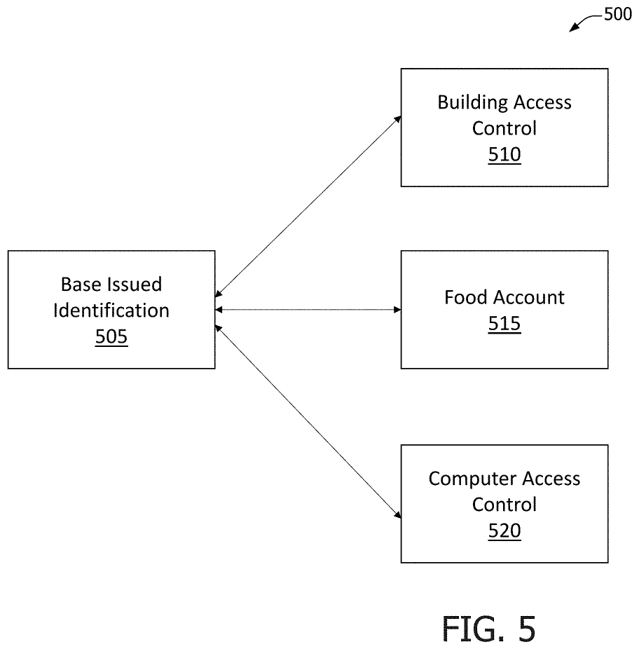

FIG. 5 illustrates a system 500 for combining multiple systems to a base issued identification 505 in a further embodiment. In some embodiments, the base issued credentials 505 are issued by a domain of trust different than the government. For example, schools and/or business may have their own domain of trust system. In these embodiments, the base issued identification 505 is issued by the domain of trust. In the business example, the human resources department may provide the base issued credentials 505 for the individuals in the company. The base issued credentials 505 could then be used to generate a token for the individual, which could be tied to the individual's mobile device. In some embodiments, the mobile device can be a smartphone or other handheld electronic device. In some further embodiments, the token could be tied to a badge or other item that the individual is supposed to have on their person.

The token can then be bound to different accounts. One such account could be building access control 510. Different employees may only have access to different buildings and/or areas. The building access control 510 would check the token at various checkpoints to ensure that the individual is allowed to access that location or area at that point in time. Another account could be a food account 515 where the individual can use the token to receive food at a company cafeteria and/or company provided vending machines. The food account 515 may be tied to a cash account that applies any food purchases made by the individual at company locations. Another account could be a computer access control 520. The computer access control 520 would require the individual to provide the token as part of their authentication process.

In another embodiment, the system 500 could be at a school, such as an elementary school or middle school, where the students might not have government issued identification 405 (shown in FIG. 4). The students could be provided with base issued identification 505 that is used to create a token for each student. The student token could be bound to building access control 510, food accounts 515, and computer access control 520. In some further embodiments, the student token could also be used to help the student determine where they need to be and when, by having access to the student's schedule.

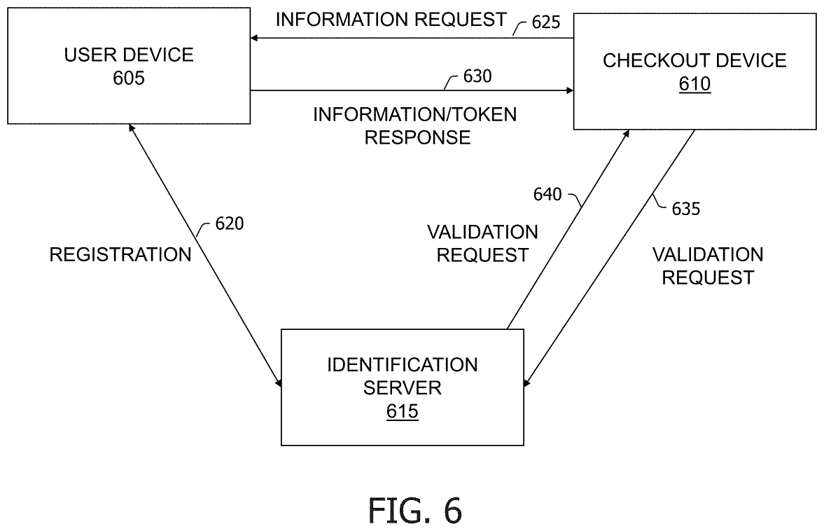

FIG. 6 illustrates a flow chart of using the supertoken shown in FIGS. 1 and 2 in a retail setting. In FIG. 6, the user device 605 stores a supertoken that is bound to the identity of the individual and to at least one payment account. The individual has previously registered 620 the user device 605 with an identification server 615.

The individual may be purchasing supplies including alcohol for a party using a point of sale (POS) system 610 at a grocery store. When the alcohol is scanned, the POS system 610 requests the individual provide personal information, i.e., their birthdate, to allow them to purchase the alcohol. The POS system 610 also requests payment information from the individual. In the exemplary embodiment, the individual can provide both the personal information and the payment information, as well as relevant attributes, privileges, identity proofing or vetting resources/process/results, affiliations/memberships, and/or validity/status, in one action. The information request 625 from the POS system 610 can include a request for any information that is needed to continue the transaction. Additionally the information request 625 can include additional, option information that can be provided, such as loyalty program information for the individual.

The POS system 610 transmits an information request 625 to the user device 605. This can be a wireless signal, such as, but not limited to, Wi-Fi, Wi-Fi Aware, Wi-Fi 33 Direct, Bluetooth, Bluetooth Low energy, Ultra-Wide Band, Near Field Communication, radio frequency identification (RFID), magnetic loop induction, high frequency audio, or other signals. The information request 625 can also be a QR code or other signifier that the user device 605 can scan from a display device of the POS system 610. In some other embodiments, the information request 625 is a text message on the display device of the POS system 610 that the individual reads. In some other embodiments, the information request 625 is an audio signal from the device of the POS system 610 that the individual's user device 605 hears.

In some embodiments, the user device 605 generates a transaction configurable QR code in response to the information request 625. In some other embodiments, the QR code includes the requested information (birthdate and payment account link) and a verification code number. In other embodiments, the QR code contains less or more information. The POS system 610 confirms the validity of the QR code by requesting validation 635 from the identification server 615. When the identification server 615 validates the information in the QR code and transmits a validity confirmation 640 to the POS system 610. Upon receiving the validity confirmation 640, the POS system 610 continues the transaction. In some embodiments, the QR code only provides a link to the information on the identification server 615. In other embodiments, the QR code includes links to some of the information and provides other information in the QR code. For example, the QR code could contain the individual's birthday, and when the POS system 610 validates the QR code, the POS system 610 uses that birthdate to determine if the individual is old enough to buy alcohol. In other embodiments, the user device 605 can provide the information to the POS system 610 wirelessly, such as, but not limited to, Wi-Fi, Wi-Fi Aware, Wi-Fi Direct, Bluetooth, Bluetooth Low energy, Ultra-Wide Band, Near Field Communication, radio frequency identification (RFID), magnetic loop induction, high frequency audio, or other signals.

The QR code can be invoked in numerous ways. The relying party can present a QR code which represents a website or traditional forms to be filled out to the individual who then scans the QR code with their phone. The individual can share their latest supertoken, created on-the-fly, based on the various statuses of the sub-tokens. Then the relying party scans the QR code to ingest the data and compute what it needs to.

Alternatively, the QR code could be replaced with “digital, machine-readable” tech. While the QR code is certainly one way to convey these token requests or return the token itself, the system may use other digital transfer technologies. In other embodiments, other technologies, such as extended superframes (ESF) technologies or other “machine-readable” transfer technologies could be used to aggregate, parse, and transmit the tokens requested. For example, ESF can be used as a security feature/differentiator, but the encoding carries a payload, and multiple ESFs can be assigned per credential. In this way the ESF can be used within its security-feature context and also used to convey the digital supertoken.

In some embodiments, the information request 625 will also include a request to know how much proofing and/or vetting was performed by the issuing party or issuer-designated 3^{rd} party when the base token was created. The QR code can include a link to the template of information that was used to validate the individual.

In another situation, an individual with a supertoken 125 on a user device 605 may be picking up a prescription at a pharmacy. To authenticate, or prove the individual is who they say they are and authorized to pick up the prescription, the individual may be required to provide a name, social security number, birthdate, and/or telephone number for the person that the prescription is for. However, providing that information out loud can allow others to learn private information. In this situation, the user could provide the requested information by having the POS system 610 scan a QR code on their user device 605 or provide a message as a wireless signal from the user device 605 to the POS system 610. The QR code or wireless message can provide the requested information about the person the prescription is for as well as provide payment information, health insurance information, or even the prescription itself with the doctor's digital signature. In some embodiments, the person the prescription is for has provided a temporary token to the individual's user device 605 authorizing them to pick-up the prescription. This allows the person the prescription is for to provide authorization without having to give the individual their personal information.

Temporary tokens may be renewable. In these embodiments, the temporary token may only last a predefined period of time, such as hours, days, weeks, etc. When the temporary token expires, a message may be transmitted to the account holder asking if they want to renew and for how long. The account user can also revoke/cancel the temporary token at any time through their user device. In some embodiments, when the temporary token is used, the account owner is asked to confirm the use of the temporary token. For example, the message may ask if Jane Doe is authorized to pick up the account owner's prescription at the pharmacy at a specific location.

In another situation, the supertoken 125 may be used to access health records and health insurance information of the individual. For example, the supertoken 125 can be linked to the Medicare number, healthcare provider number, insurance info, medical history information (such as immunizations, COVID testing or vaccine information) and other medical records. In some embodiments, the supertoken 125 allows the healthcare provider to access the secure records of the individual. In other embodiments, only certain parts of the medical history of the user may be provided. For example, the medical information available may be that the user has been vaccinated against COVID or other diseases, but not include when the vaccines were, where, or any other medical history data of the user.

In a further situation, the supertoken 125 may be used to prove age for access to a location such as a bar and establish a tab for ordering drinks and food for their group. Rather than requiring a bouncer or doorman to make a judgment based on a photo identification, the individual requesting access can show a QR code on their user device 605 that could be scanned to provide proof of age, without providing other unneeded information, such as the address of the individual. Simultaneously, the bartender's POS device 610 receives the supertoken 125 to create a tab for the individual or their group based on payment information or mechanism embodied in the supertoken 125 along with a photo to display on the bartender's POS device 610 at check out.

In a further embodiment, the supertoken 125 could provide information to emergency personnel. In an emergency situation, such as the individual having a stroke or seizure, the emergency personnel can scan the patient's user device 605 to access the token to receive basic information about the individual to assist in their treatment. In these embodiments, the supertoken 125 could provide basic statistics, next of kin information, allergies, and other emergency-centric information that might typically be on a medical alert bracelet.

In these embodiments, the emergency personnel may have a supertoken 125 on their user device 605 that validates them as emergency personnel that are on duty (validated on a shift) that would allow them to send an emergency information request to the patient's user device 605. The patient's user device 605 may then provide the information without requiring interaction from the user, as in an emergency situation, the patient may be unable to interact with the device. This system may allow the information to be transferred even if the display device/touchscreen is broken on the patient's user device 605. In some further embodiments, the patient may set-up preferences based on which information to share with emergency personal, including special bulletins about allergies, etc.

In some further embodiments, the emergency medical personnel could use a medical 911 available on the user device 605 to receive “delegation” to pull the data? The medical 911 could be used to unlock the device for emergency use. Then the user device 605 would use Facial Recognition or other biometric data to unlock access to the supertoken 125. While the victim may be unconscious, but the facial recognition could still work based on their injuries.

In these above embodiments, the supertoken allows for information to be shared with those that need it, but not with those standing nearby. This greatly increases the privacy of individuals.

In another example, the supertoken 125 can be tied to the identity of a vehicle. The supertoken 125 can be used to remotely start and unlock the vehicle through the user device 605. In some embodiments, the supertoken 125 could be a part of two-factor authentication to start up the vehicle. The other factor could actually be a key or key fob. In some further embodiments, the user device 605 and the supertoken 125 would provide information on the driver, such as, but not limited to, status of insurance, status of driver's license (is it still valid), status of any certifications and endorsements of the driver (hazmat), etc. The endorsements represent various eligibilities and privileges not necessarily tied to driving. For example, an armored car driver needs to have an appropriate commercial driver's license (CDL), but also need to have a license to carry (LTC).

In commercial trucking, the supertoken 125 could be bound to information about the vehicle and the load that the driver is transporting. The driver could use the user device 605 and the supertoken to provide information to the Department of Agriculture, Department of Commerce, Department of Transportation, law enforcement, border patrol, and warehouses at the beginning and ending of the trip. Each container that is being shipped could also have a token associated with it. When the driver picks up a container, the container's token is bound to the driver's supertoken 125. When the container is dropped off, the container's token is transferred to the warehouse or drop-off location. The driver's supertoken 125 would keep a record of the connections of containers picked-up, dropped off, and when.

In a rental vehicle ecosystem, the individual could have a reservation for a rental vehicle attached to their supertoken 125. Rather than standing in line, the individual could pick out a vehicle by walking up to it and scanning the vehicle with their user device 605. The rental vehicle computer could assign that vehicle to the individual and provide their supertoken 125 with an unlocking and starting key that allows the individual to start the vehicle from their user device 605. The payment information, insurance information, and driver's license information is provided to the rental company by the supertoken 125 to allow the user to scan the vehicle, unlock it, start it, and then drive the vehicle, with the negotiation taking place seamlessly among the user device 605, the rental company, and any other necessary RPs for the transaction. This risk of the transaction is lowered by issuing of a digital supertoken 125 by the relying party that binds to the renter's information and previously issued credentials and related privileges (like not allowed to drive at night). In other embodiments, for crowd sharing vehicles, the relying party may be an individual that owns the car and there is a binding of their insurance and registration info to assure the renter that the owner is legitimate and approved (safe) and there is a day and time period limit associated with access and driving.

In another similar travel-based embodiment, the supertoken 125 on the user device 605 is scanned at check-in or a security checkpoint, initiating a message being transmitted to the travel dependency vendors down the line, such as, but not limited to, airline, hotel, car rental company, and others, including data parsed from the supertoken required by those relying parties to verify identity, deliver concierge or VIP services, or que up and process the upcoming transaction. The down the line vendors would then know the individual is coming and can ensure they have their services ready (room and car available, etc.). The supertoken 125 can also provide information about the individual's flight, such as flight number. The down the line vendors can then know when the individual is estimated to arrive and if their travel has been delayed or canceled. In the case of a flight being cancelled, the supertoken 125 can update those down the line vendors of the alternative travel plans. The supertoken 125 can also provide updates to the down the line vendors, such as, but not limited to, when the user checks in, when the user clears security, when the user boards the plane/train, when the plane/train leaves, when the plane/train arrives, and when the user gets their luggage, etc. The supertoken 125 can also include links to information about the traveler's luggage.

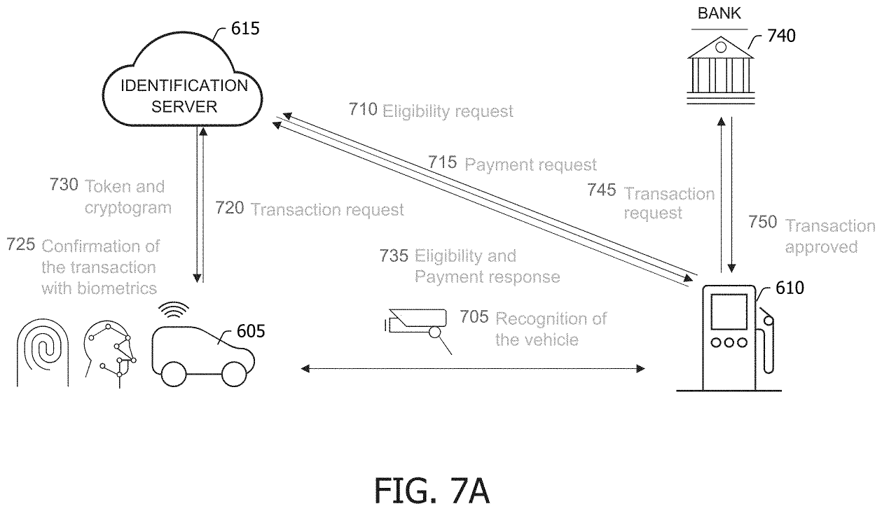

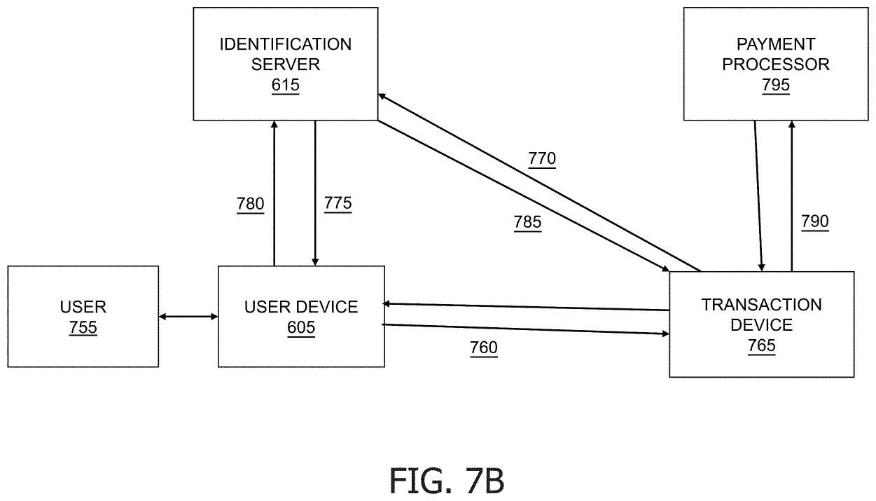

FIGS. 7A and 7B illustrate flow charts of using the supertoken 125 shown in FIGS. 1 and 2 in transaction settings.

In FIG. 7A, a vehicle (which could be considered a user device 605) reaches a POS system 610. In the Figure, POS system 610 is illustrated as a gas pump. In other embodiments, the POS system 610 could be a toll station, a parking station, and/or any other POS style device 610. The POS system 610 recognizes 705 the vehicle (user device 605). This recognition 705 may be done by visual scanning of the license plate or other information on the vehicle. The recognition 705 may also be done by receiving identifying information wirelessly transmitted to the POS system 610, such as, but not limited to, the supertoken 125 and/or a portion of the supertoken 125.

The POS system 610 transmits an eligibility request 710 to an identification server 615 associated with the vehicle. The eligibility request 710 can also include, or be sent simultaneously to, a payment request 715. The identification server 615 transmits a transaction request 720 to the vehicle (user device 605). The user device 605 interacts with the user to confirm the transaction with biometric information 725 from the user. The biometric information 725 may be a facial scan, fingerprint scan, iris scan, and/or any other biometric information available to the identification server 615 and the user device 605. When the user is confirm, the user device 605 may transmits 730 the supertoken 125 to the identification server 615. The user device 605 can also transmit any cryptographic information necessary for the identification server 615 to access the supertoken 125.

The identification server 615 can then validate the user and transmit 735 the payment information, and any other required information, to the POS system 610. The POS system 610 may then access 745 a banking computer system 740 for the transaction using the information provided by the identification server 615 and the user device 605. The POS server 610 may receive a transaction approved message 750 from the banking computer system 740.

FIG. 7A many of the points of this diagram can be considered proxies within an ecosystem. The proxies can be applied to many of the different supertoken workflows. This is explored more in FIG. 7B.

In FIG. 7B, a user 755 with an associated user device 605 transmits a request for a transaction 760 to a transaction device 765. The requested transaction could be anything, from access to a location, to a financial transaction, to access to information, or any other transaction that allows the user 755 access to a system.

The transaction device 765 receives the transaction request 760 from the user device 605. The transaction device 765 requests 770 authentication, and potentially additional information from the identification server 615. The identification server 615 transmits an authentication request 775 to the user device 605, where the user device 605 may request biometric information from the user 755. The user device 605 transmits 780 the biometric information or the results of the authentication back to the identification server 615. In response to a positive validation, the identification server 615 provides 785 authentication results and the additional information to the transaction device 765. In some embodiments, the identification server 615 retrieves the additional information from the supertoken 125 or a database with the associated information.

In some embodiments, the transaction device 765 provides the transaction, such as access to a location or information. In other embodiments, the transaction requires payment. In these embodiments, the transaction device 765 requests and receives payment authorization 790 from a payment processor 795, such as one associated with a payment account.

FIG. 8 illustrates a block diagram of an exemplary system 800 for supporting the supertoken 125 (shown in FIGS. 1 and 2). In at least one embodiment, the system 800 allows a user to remotely enroll and create a base token 205 (shown in FIG. 2). For example, an individual uses their user device 805 to access a provisioning server 810, such as through a website or application. The provisioning server 810 is in communication with a government entity computer device 815, where the government entity may be the department of motor vehicles, the social security administration, or any other governmental entity. In other embodiments, the government entity can be replaces with an issuer or a designated 3^{rd} party. The mobile device 805 captures an image of the front and the back of the individual's driver's license. The mobile device 805 also captures a picture or pictures of the individual's face. The images are then transmitted to the provisioning server 810. The provisioning server 810 may perform a proof of life check on the picture(s) of the individual, to ensure that the picture is a live picture of the individual and not a still picture of the individual. This is to ensure the individual is present at the user device 805.

The provisioning server 810 interacts with the government entity computer device 815 to verify, or confirm, the information provided in the images of the driver's license. If the information is confirmed, then the provisioning server 810 is able to generate a base token 205 for the user device 805. The base token 205 binds the government entity identification 405 (shown in FIG. 4) and the user device 805 to that base token 205. The base token 205 can then be considered a digital credential for the individual. Using the base token 205 the individual could gain access to the government entity computer device 815 and update information and/or attributes of the individual, such as current address.

In some embodiments, the base token 205 includes a unique identifier for the user device 805 in the base token 205. In the exemplary embodiment, the base token 205 is stored in the memory 820 of the user device 805. The base token 205 can also include one or more attributes 825 of the individual with the token. The base token 205 may be stored in a secure memory location 820 on the user device 805. If the individual has multiple user devices 805, the individual may have base tokens 205 on each user device 805; however, each base token 205 will be different because the user devices 805 (and device number) are different. A base token 205 (and corresponding supertokens 125 (shown in FIG. 1)) will not work on devices other than the one that the base token 205 was originally provisioned on.

In some embodiments, the provisioning server 810 stores an index number 835 for the base token 205 in a connected database 830. In some embodiments, the index number 835 is based on the device number or driver's license number. For security reasons, the index number 835 may be a hashed and/or salted version of this number. In some embodiments, the provisioning server 810 only stores the index number 835 that may point to information in the government entity computer device 815 that would then store the user attributes 845 in a database 840. In this way, the provisioning server 810 is secure and will not provide information about the individual if compromised.

By using the token, the transactions for the individual are then anonymized. The base token 205 allows the individual to authenticate every time the individual's information is shared. For example, in the retail example of FIG. 6, the individual would be asked permission before generating the QR code or otherwise providing the token. The access request 625 (shown in FIG. 6) could include information such as what pieces of information are being shared and who is requesting the information. The individual may also be able to view his/her history of shared data and see a list of what attributes 825 were shared, when, and with whom.

In some embodiments, a token for an account may be replaced with another token for that account. This may be in the case where the account upgrades the security of the token or requires different information. In these embodiments, the supertoken 125 may be re-generated with the new, upgraded token. This may involve removing the first token from the supertoken 125 and then binding the supertoken to the new token.

In other embodiments, an account token may be removed or revoked, where the account token is unbound from the supertoken 125.

In other embodiments, the relying party may need different levels of security for access to different items. For example, if a dependent is using the individual's loyalty card in a transaction to buy gum, then the security for providing access to the loyalty program would be low. However, if the dependent also wants to use the individual's payment account to pay, then the security requirements are higher. In the first case, only one item of authentication information is required to be provided by the supertoken 125. In the second case, multiple items of authentication information are required to be provided by the supertoken 125. In other embodiments, information can be transmitted by other methods, such as, but not limited to, Wi-Fi, Wi-Fi Aware, Wi-Fi 33 Direct, Bluetooth, Bluetooth Low energy, Ultra-Wide Band, Near Field Communication, radio frequency identification (RFID), magnetic loop induction, high frequency audio, or other signals.

While sitting in a vehicle that the individual owns or has purchased, the individual can use the mobile device 805 to connect the vehicle to the government entity. The individual may scan one or more parts of the vehicle, such as the Vehicle Identification Number (VIN) and provide the VIN to the government entity along with the individual's base token 205. The individual may then be able to register the vehicle without having to visit a Department of Motor Vehicles. Since the individual's insurance information may also be bound to the base token 205, the insurance information can also be provided to the government entity while the vehicle information is shared with the insurance entity. In some embodiments, the vehicle token may be provided by the dealer or seller of the vehicle.

If the issuer or designated 3^{rd} Party database 840 is improperly accessed, hacked, or otherwise misappropriated, the government entity can delete all of the tokens and reissue new tokens with a new seed or key. The provisioning server 810 can then transfer the bindings from the old token to the new token. The provisioning server can also transfer the bindings from an old token to a new token when a part of the base token is changed, such as when the individual renews their driver's license or buys a new mobile device or smart phone.

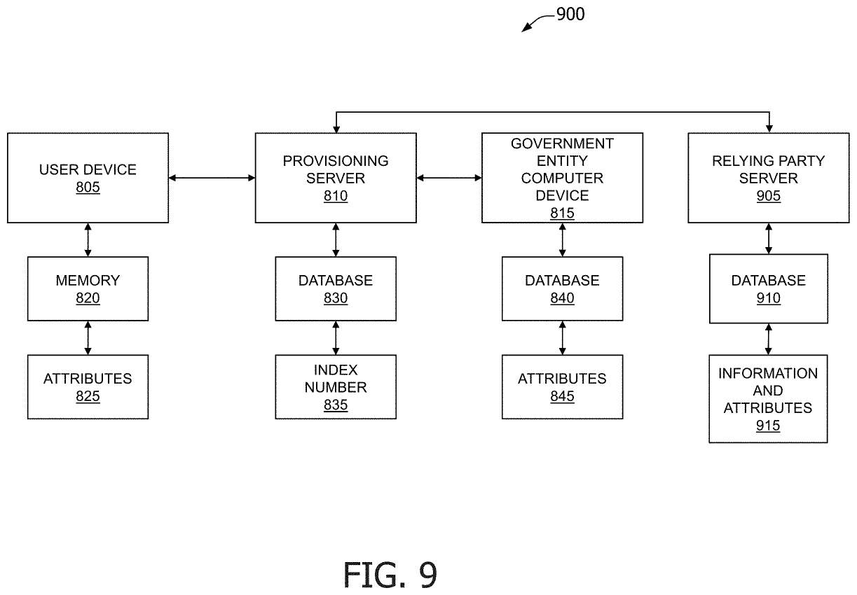

FIG. 9 illustrates a block diagram of an exemplary system 900 for using the supertoken 125 (shown in FIGS. 1 and 2). In the exemplary embodiment, the user activates their user device 805 to add a token from a relying party to their supertoken 125. The relying party may be a financial institution and the token associated with an account number or payment account number. The relying party may also be associated with an IoT device. In addition, the relaying party may be associated with a vehicle and the token associated with keyless entry and activation of the vehicle. Or the relying party may be any other system associated with a token that can be bound to the supertoken 125.

In some embodiments, the user device 805 connects to the relying party server 905 to request information and attributes associated with the relying party's token. In other embodiments, the provisioning server 810 connects to the relying party server 905. The relying party server 905 requests authentication information from the user device 805 and/or the provisioning server 810 to authenticate the user. When the user is authenticated, the relying party server 905 provides the requested information and attributes. The user device 805 and/or the provisioning server 810 adds the necessary information and attributes about the relying party to the supertoken 125, thus binding the relying party's token to the supertoken 125.

When the user desires to access the relying party, such as accessing the payment account, the user device 805 may transmit the supertoken 125 or a portion of the supertoken 125 to the relying party server 905. The relying party server 905 retrieves the desired information from the supertoken 125 and compares the retrieved information to the information and attributes 915 stored in the database 910. If the information matches/authenticates, then the relying party server 905 allows the user device access to its corresponding system.

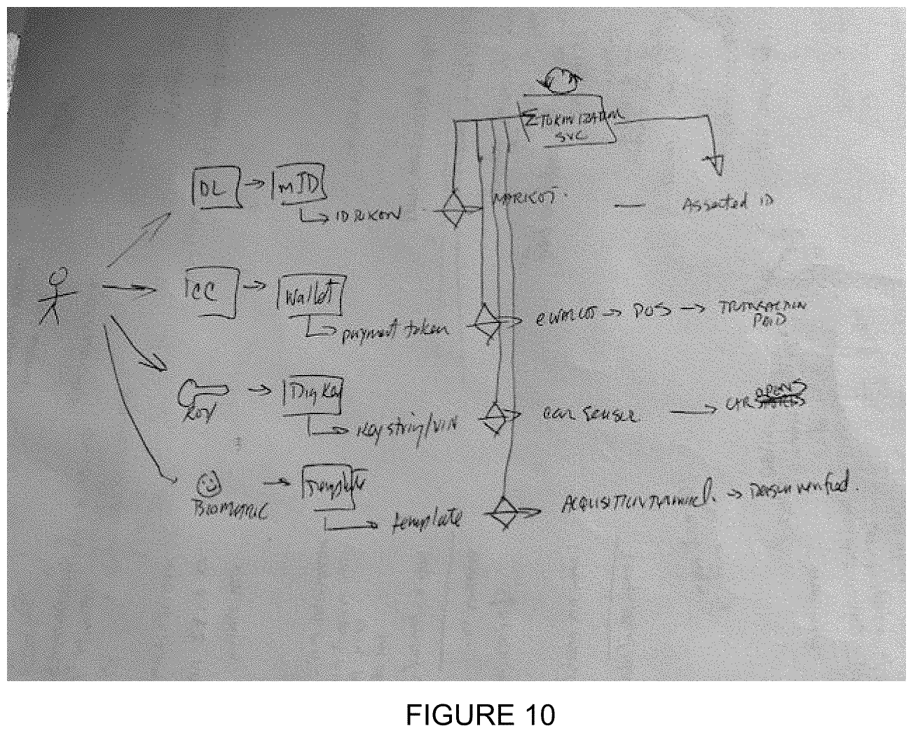

FIG. 10 illustrates a block diagram of a system for connecting multiple tokens. The user is associated with multiple accounts and/or digital ecosystems. The top system is a driver's license associated with a mID, which includes an ID token. A credit card or payment card is associated with a wallet that includes a payment token. A key, such as for a vehicle or a house, is associated with a digital key. The digital key can be a key string, such as a VIN. Biometric data are associated with the user and stored in a template. The Tokenization service combines the ID token, the payment token, the key string/VIN, and the template to generate a supertoken.

The supertoken can be asserted as identification. The eWallet can interact with a POS system to allow an individual to pay for a transaction. The car or vehicle can detect the key string in the supertoken, which allows the user to unlock the vehicle. The biometric template can be used to acquire biometric information from the user to verify the user by comparing the acquired biometric information to that stored in the template.

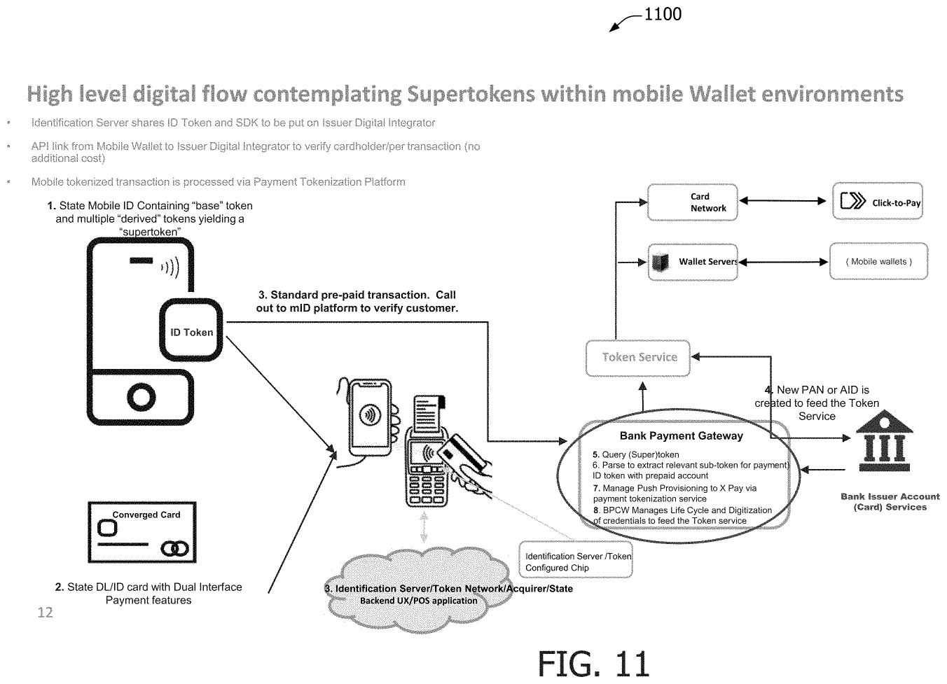

FIG. 11 illustrates a block diagram of a system 100 integrating digital wallets with supertokens 125 (shown in FIGS. 1 and 2). FIG. 11 shows taking a base token 205 (shown in FIG. 2) and multiple derived token to generate a supertoken 125 stored on a user device 605 (shown in FIG. 6). The supertoken 125 is combined with government issued identification 405 (shown in FIG. 4). The user device 605 is then used for a transaction, such as a pre-paid transaction at a POS system 610 (shown in FIG. 6). The supertoken 125 is authenticated through the identification server 615 (shown in FIG. 6).

The token service includes a PAN or AID that was created by the issuing bank. The POS system 610 then accesses a bank payment gateway. The gateway, queries the supertoken 125 to parse/extract the relevant sub-token or information for payment which is associated with an account, such as a pre-paid account. The gateway pushes the token information and transaction information to the appropriate wallet and/or card network. The appropriate wallet and/or card network is used to process the transaction and/or feed the token service as needed.

As used herein, a processor can include any programmable system including systems using micro-controllers; reduced instruction set circuits (RISC), application-specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Wash.). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, Calif.). In yet a further example, the system is run on a Mac OS® environment (Mac OS is a registered trademark of Apple Inc. located in Cupertino, Calif.). In still yet a further example, the system is run on Android® OS (Android is a registered trademark of Google, Inc. of Mountain View, Calif.). In another example, the system is run on Linux® OS (Linux is a registered trademark of Linus Torvalds of Boston, Mass.). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The patent claims at the end of this document are not intended to be construed under 35 U.S.C. § 112(f) unless traditional means-plus-function language is expressly recited, such as “means for” or “step for” language being expressly recited in the claim(s).

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The methods and system described herein can be implemented using computer programming or engineering techniques including computer software, firmware, hardware, or any combination or subset. As disclosed above, at least one technical problem with prior systems is that there is a need for systems for monitoring communication networks, where the networks can change over time. The system and methods described herein address that technical problem. Additionally, at least one of the technical solutions to the technical problems provided by this system can include: (i) combining tokens provided by multiple systems into a supertoken; (ii) transmitting necessary portions of the supertoken to the necessary systems for access; (iii) allowing access to systems using the supertoken; (iv) reducing the processing necessary to provide access to systems; and (v) improving security and control of access tokens.

The methods and systems described herein can be implemented using computer programming or engineering techniques including computer software, firmware, hardware, or any combination or subset thereof, wherein the technical effects can be achieved by performing at least one of the following steps: a) receive identity information for an individual; b) receive device identity information for the computer device; c) combine the identity information and the device identity information to generate a base token; d) receive payment card information for a payment card associated with the individual; and e) combine the base token with the payment card information to generate a supertoken.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for combining tokens comprising a computer device comprising at least one processor in communication with at least one memory device, the at least one processor programmed to:
receive identity information for an individual;
receive device identity information for the computer device;
combine the identity information and the device identity information to generate a base token;
receive payment card information for a payment card associated with the individual; and
combine the base token with the payment card information to generate a supertoken.
